(19) United States
(12) Patent Application Publication
(10) Pub. No.: US 2006/0274869 A1
(43) Pub. Date: Dec. 7, 2006

(54) Dynamically generating content based on capabilities of a mobile device

(75) Inventor: Jason Morse, Mountain View, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/407,451

(22) Filed: Apr. 19, 2006

Related U.S. Application Data
(60) Provisional application No. 60/688,121, filed on Jun. 7, 2005.

(51) Int. Cl. H04B 1/10

(52) U.S. Cl. 375/352

(57) ABSTRACT

A system, apparatus, and method is directed to dynamically generating content on the fly based on at least one characteristic of a computing device requesting the content, including a characteristic of a network connection. The invention may receive information from a variety of sources, including a manufacturer of the computing device, a header sent by the computing device, and specific test results performed on computing devices similar to the requesting computing device. The information may include screen size, screen resolution, memory size, browser capabilities, applications supported, and so forth. The network connection information may include bandwidth, delays, degradation, connection type, and so forth. The information may be combined to determine an overall device profile. When a request for content is made, the server may employ the device profile to dynamically format the content and provide it optimized for the computing device.

### CROSS-REFERENCE TO RELATED APPLICATIONS

This application claims the benefit of U.S. Provisional Application Ser. No. 60/688,121 filed on Jun. 7, 2005, the benefit of the earlier filing date of which is hereby claimed under 35 U.S.C. §119 (e) and further incorporated by reference.

### FIELD OF THE INVENTION

The invention relates generally to mobile communications, and more particularly but not exclusively to dynamically generating content for a mobile device based, in part, on capabilities of the mobile device.

### BACKGROUND OF THE INVENTION

The growth of the Internet has brought a corresponding increase in the number and variety of computing devices being employed to communicate over the Internet. Today's computing devices vary from desktop computers with a large variety of features and capabilities, to mobile devices such as pagers, cellular phones, personal digital assistants (PDAs), and the like, with lesser features and/or capabilities. For example, many of these computing devices include some form of Internet browsing capability. In addition, many of the computing devices are configured to allow users access to audio files, and/or graphical files via wireless and/or wired networks. However, access to some content may be more difficult as a result of various limitations, including those of the computing devices, bandwidth, and/or other factors. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a mobile device that may be included in a system implementing the invention;

FIG. 3 shows one embodiment of a server device that may be included in a system implementing the invention; and

FIG. 4 illustrates a logical flow diagram generally showing one embodiment of a process of dynamically generating content virtually on the fly to be sent to a computing device based, at least in part, on a communication channel and a capability of the computing device, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Briefly stated, the present invention is directed towards a system, apparatus, and method for dynamically generating content on the fly based on a capability of a computing device requesting the content, including a current network connection. The invention may receive information from a variety of sources, including a manufacturer of the computing device, a header sent by the computing device, specific test results performed on computing devices similar to the requesting computing device, and so forth. In one embodiment, the information is obtained from a user agent profile. The information may include screen size, screen resolution, memory size, browser capabilities, applications supported, and the like. The current network connection information may include bandwidth information, delay information, degradation information, connection type, and so forth. The information may be combined to determine an overall computing device profile. When a request for content is made, the server may employ the overall computing device profile to dynamically format the content and provide it optimized for the computing device.

Illustrative Operating Environment

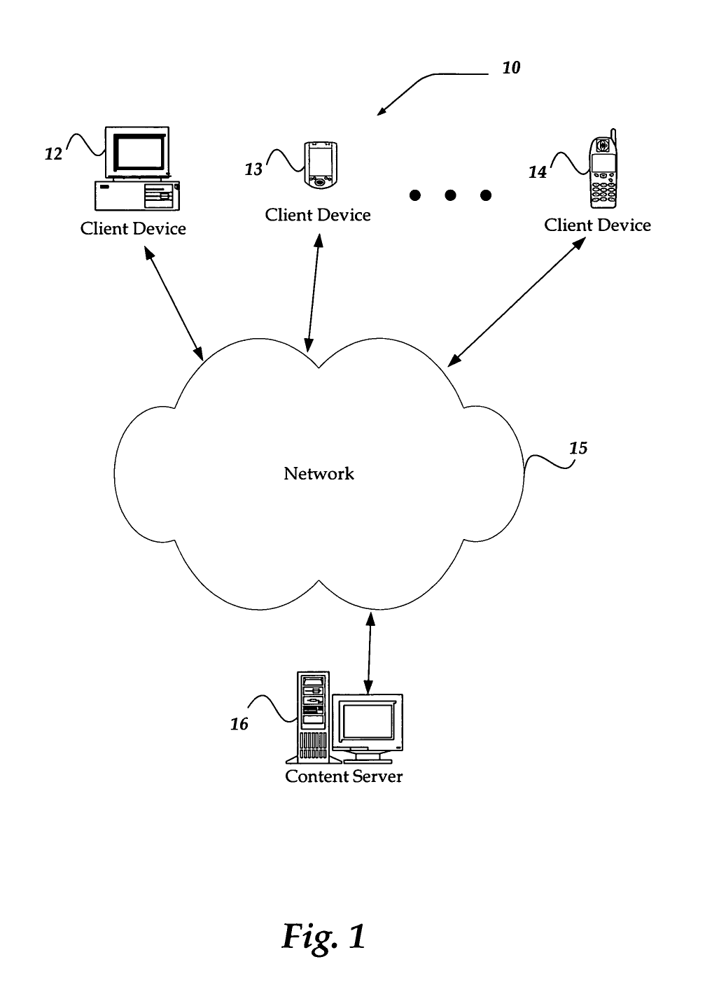

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, system 10 may include client devices 12-14, network 15, and content server 16. Network 15 is in communication with and enables communication between each of client devices 12-14, and content server 16.

Client devices 12-14 may include virtually any computing device capable of receiving and sending a message over a network, such as network 15, to and from another computing device, such as content server 16, each other, and the like. The set of such devices described in an exemplary embodiment below generally includes mobile devices that are usually considered more specialized devices with limited capabilities and typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. However, the set of such devices may also include devices that are usually considered more general purpose devices and typically connect using a wired communications medium at one or more fixed location such as laptop computers, personal computers, multiprocessor systems, microprocessor-based or programmable consumer electronics, network PCs, and the like. Similarly, client devices 12-14 may be any device that is capable of connecting using a wired or wireless communication medium such as a personal digital assistant (PDA), POCKET PC, wearable computer, and any other device that is equipped to communicate over a wired and/or wireless communication medium.

Each client device within client devices 12-14 includes a user interface that enables a user to control settings, and to instruct the client device to perform operations. Each client device also includes a communication interface that enables the client device to send and receive messages to/from another computing device employing the same or a different communication means, including, but not limited to SMS, MMS, IM, internet relay chat (IRC), Mardam-Bey's internet relay chat (mIRC), Jabber, email, and the like.

Client devices 12-14 may be further configured with a browser application that is configured to receive and to send content in a variety of forms, including, but not limited to markup pages, web-based messages, audio files, graphical files, file downloads, applets, scripts, and the like. The browser application may be configured to receive and display graphics, text, multimedia, and the like, employing virtually any markup based language, including, but not limited to a Handheld Device Markup Language (HDML), such as Wireless Markup Language (WML), WMLScript, JavaScript, and the like, Standard Generalized Markup Language (SGML), HyperText Markup Language (HTML), Extensible Markup Language (XML).

Because each client device within client devices 12-14 may vary in size, shape, and capabilities, client devices 12-14 may also be configured to provide device profile information about its capabilities including whether the client device is capable of receiving particular types of audio files, graphical files, web-based files, and the like. Client devices 12-14 may also provide device profile information that may include an available application on the client device, version information, and the like.

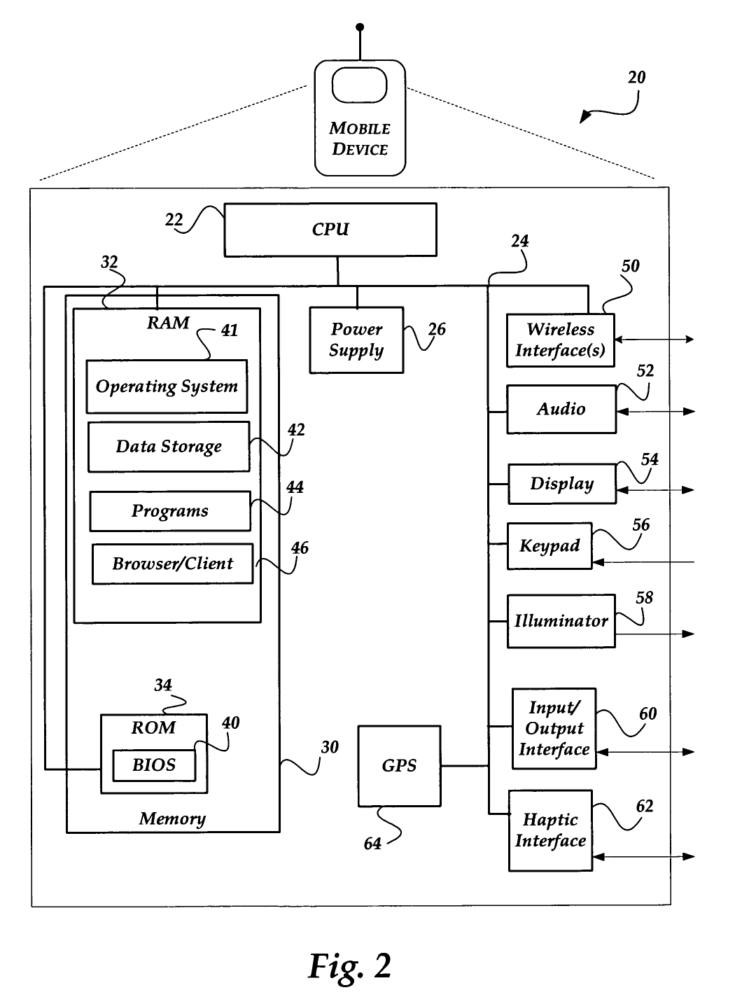

Client devices 12-14 may also provide an identifier. The identifier may employ any of a variety of mechanisms, including a device model number, a carrier identifier, a mobile identification number (MIN), and the like. The MIN is often a telephone number, a Mobile Subscriber Integrated Services Digital Network (MS-ISDN), an electronic serial number (ESN), or other device identifier. In one embodiment, the identifier, and the device profile information is sent with each message to another computing device, such as content server 16. However, the invention is not so limited, and the identifier and device profile information may be sent based on a request for such information, an event, or so forth. One embodiment of a client device (12-14) configured as a mobile device is described in more detail below in conjunction with FIG. 2.

Network 15 is configured to couple one computing device to another computing device to enable them to communicate. Network 15 is enabled to employ any form of medium for communicating information from one electronic device to another. Also, network 15 may include a wireless interface, such as a cellular network interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize cellular telephone signals over air, analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 15 includes any communication method by which information may travel between client devices 12-14, and content server 16. Network 15 is constructed for use with various communication protocols including wireless application protocol (WAP), transmission control protocol/internet protocol (TCP/IP), code division multiple access (CDMA), global system for mobile communications (GSM), and the like.

The media used to transmit information in communication links as described above generally includes any media that can be accessed by a computing device. Computer-readable media may include computer storage media, wired and wireless communication media, or any combination thereof. Additionally, computer-readable media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wireless media such as acoustic, RF, infrared, and other wireless media, and wired media such as twisted pair, coaxial cable, fiber optics, wave guides, and other wired media.

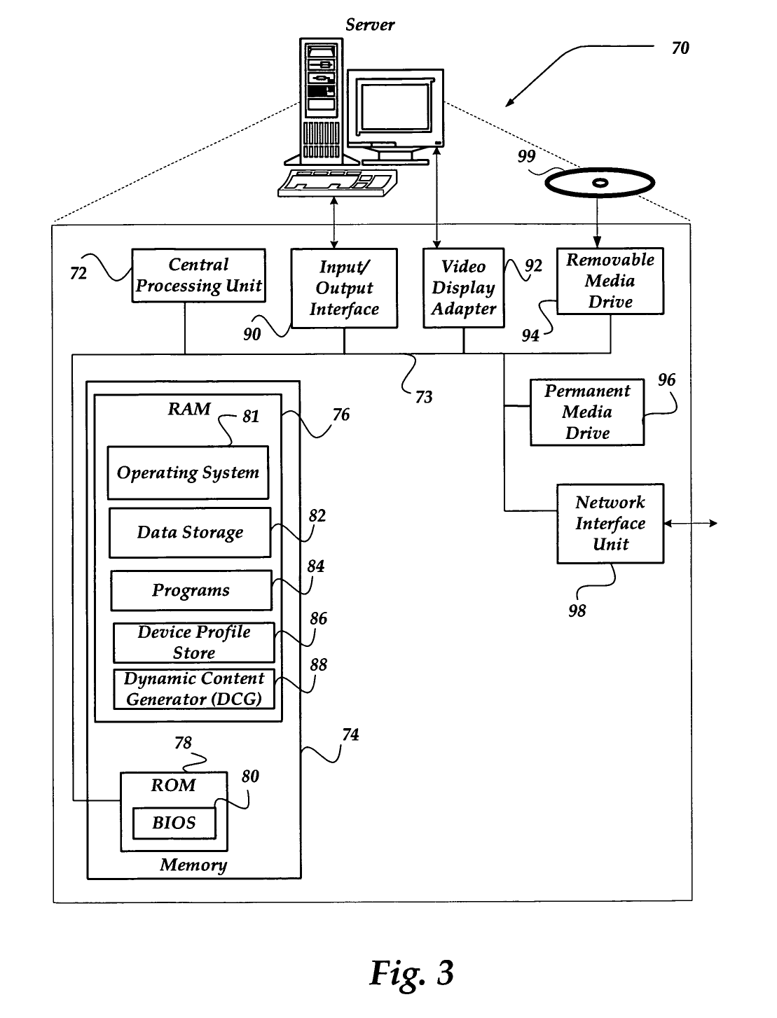

One embodiment of content server device 16 is described in more detail below in conjunction with FIG. 3. Briefly, however, content server 16 includes virtually any computing device capable of connecting to network 15 to receive and provide services and information to client devices and/or other computing devices. In particular, content server 16 is configured to receive a request for content, and to dynamically format a response that is configured based on a capability of the requesting computing device, including its network connection.

Content server 16 may determine the format for the response based on a variety of information that it has obtained about the requesting device, characteristics of a communication link with content server 16, and the like. For example, content server 16 may receive device profile information from the requesting device. Similarly, content server 16 may receive characteristics about the requesting device from a variety of other sources, including test information about a client device substantially similar to the requesting device, information about client devices similar to the requesting device from a vendor, and the like. In addition, content server 16 may obtain measurement information about a characteristic of the communication link, including a bandwidth, quality of server, a packet lose count, a round trip time (RTT), a load metric, and so forth. Virtually any metric regarding a characteristic of the communication link may be employed.

Content server 16 may combine the received information in any of a variety of ways, including averaging information about similar characteristics of the requesting device, taking a minimum value, a maximum value, or the like. Content server 16 may employ the combined information to dynamically format the requested content, web-page, and the like, to optimize throughput and efficiency of communication of the requested content to the requesting device. For example, if content server 16 determines that the bandwidth of the communication link is at some low threshold, the content could be dynamically formatted with reduced resolution, provided as smaller and/or less complex components, and so forth.

Although only a single content server 16 is illustrated in FIG. 1, the present is not so constrained. For example, content may be served from a plurality of content servers, including a content server farm, a distributed server architecture, and the like, without departing from the scope or spirit of the invention.

In another embodiment content server 16 may be configured to operate as a portal server. In this example configuration, content server 16 may generally aggregate content from a wide variety of content subjects, and sources including news, economic information and services, messaging services, online search services, entertainment services, social interaction services, and the like. Such content may be routed from one or more other content servers, database servers, and the like, through content server 16, where content server 16 may then employ the device profile to dynamically format the content virtually on the fly as it provided to the requesting device.

Illustrative Mobile Device

FIG. 2 shows an exemplary mobile device 20, according to one embodiment of the invention. In one embodiment, mobile device 20 is a cellular telephone that is arranged to send and receive voice communications and messages such as SMS messages via one or more wireless communication interfaces. Generally, mobile device 20 may comprise any personally mobile electronic device. Oftentimes, mobile electronic devices will be capable of personal communication by connecting to one or more wireless networks, connecting to multiple nodes of a single wireless network, communicating over one or more channels to one or more networks, or otherwise engaging in one or more communication sessions. Such devices include cellular telephones, smart phones, pagers, radio frequency (RF) devices, infrared (IR) devices, integrated devices combining one or more of the preceding devices, and the like. Mobile device 20 may also comprise other electronic devices that such as Personal Digital Assistants (PDAs), handheld computers, personal computers, multiprocessor systems, microprocessor-based or programmable consumer electronics, network PCs, wearable computers, and the like.

Mobile device 20 may include many more components than those shown in FIG. 2. However, the components shown are sufficient to disclose an illustrative embodiment for practicing the present invention. As shown in the figure, mobile device 20 includes a processing unit 22 in communication with a mass memory 30 via a bus 24.

Mass memory 30 includes a RAM 32, a ROM 34, and other storage means. Mass memory 30 illustrates another example of computer storage media for storage of information such as computer readable instructions, data structures, program modules or other data. Mass memory 30 stores a basic input/output system (“BIOS”) 40 for controlling low-level operation of mobile device 20. The mass memory also stores an operating system 41 for controlling the operation of mobile device 20. It will be appreciated that this component may include a general purpose operating system such as a version of UNIX, or LINUX™, or a specialized mobile communication operating system such as Windows Mobile™, or the Symbian® operating system. The operating system may include, or interface with a Java virtual machine module that enables control of hardware components and/or operating system operations via Java application programs.

Memory 30 further includes one or more data storage 42, which can be utilized by mobile device 20 to store, among other things, programs 44 and/or other data. For example, data storage 42 may also be employed to store information that describes various capabilities of mobile device 20. The information may then be provided to another device based on any of a variety of events, including being sent as part of a header during a communication, sent upon request, and the like. A sample header is provided in Appendix B that illustrates various types of device capability information that might be provided.

Programs 44 may include computer executable instructions which, when executed by mobile device 20, transmit, receive, and/or otherwise process messages (e.g., SMS, MMS, IM, email, and/or other messages), audio, video, and enable telecommunication with another user of another mobile device. Other examples of application programs include calendars, contact managers, task managers, transcoders, database programs, word processing programs, spreadsheet programs, games, and so forth. In addition, mass memory 30 stores a browser program 46. Browser 46 may include computer executable instructions, which may be run under control of operating system 41 to enable and manage requesting, receiving, and rendering markup pages such as WAP pages (sometimes referred to as WAP cards), and the like.

Mobile device 20 also includes a power supply 26, one or more wireless interfaces 50, an audio interface 52, a display 54, a keypad 56, an illuminator 58, an input/output interface 60, a haptic interface 62, and an optional global positioning systems (GPS) receiver 64. Power supply 26 provides power to mobile device 20. A rechargeable or non-rechargeable battery may be used to provide power. The power may also be provided by an external power source, such as an AC adapter or a powered docking cradle that supplements and/or recharges a battery.

Mobile device 20 may optionally communicate with a base station (not shown), or directly with another mobile device. Wireless interface 50 includes circuitry for coupling mobile device 20 to one or more wireless networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), and the like.

Audio interface 52 is arranged to produce and receive audio signals such as the sound of a human voice. For example, audio interface 52 may be coupled to a speaker and microphone (not shown) to enable telecommunication with others and/or generate an audio acknowledgement for some action. Display 54 may be a liquid crystal display (LCD), gas plasma, light emitting diode (LED), or any other type of display used with a mobile device. Display 54 may also include a touch sensitive screen arranged to receive input from an object such as a stylus or a digit from a human hand.

Keypad 56 may comprise any input device arranged to receive input from a user. For example, keypad 56 may include a push button numeric dial, or a keyboard. Keypad 56 may also include command buttons that are associated with selecting and sending images. Illuminator 58 may provide a status indication and/or provide light. Illuminator 58 may remain active for specific periods of time or in response to events. For example, when illuminator 58 is active, it may backlight the buttons on keypad 56 and stay on while the mobile device is powered. Also, illuminator 58 may backlight these buttons in various patterns when particular actions are performed, such as dialing another mobile device. Illuminator 58 may also cause light sources positioned within a transparent or translucent case of the mobile device to illuminate in response to actions.

Mobile device 20 also comprises input/output interface 60 for communicating with external devices, such as a headset, or other input or output devices not shown in FIG. 2. Input/output interface 60 can utilize one or more communication technologies, such as USB, infrared, Bluetooth™, and the like. Haptic interface 62 is arranged to provide tactile feedback to a user of the mobile device. For example, the haptic interface may be employed to vibrate mobile device 20 in a particular way when another user of a mobile device is calling.

Optional GPS transceiver 64 can determine the physical coordinates of mobile device 20 on the surface of the Earth, which typically outputs a location as latitude and longitude values. GPS transceiver 64 can also employ other geo-positioning mechanisms, including, but not limited to, triangulation, assisted GPS (AGPS), E-OTD, CI, SAI, ETA, BSS and the like, to further determine the physical location of mobile device 20 on the surface of the Earth. It is understood that under different conditions, GPS transceiver 64 can determine a physical location within millimeters for mobile device 20; and in other cases, the determined physical location may be less precise, such as within a meter or significantly greater distances.

Illustrative Server Device

FIG. 3 shows one embodiment of a server device that may be included in a system implementing the invention. For example, server device 70 may be employed as content server 16 in FIG. 1.

Server device 70 may include many more components than those shown. The components shown, however, are sufficient to disclose an illustrative embodiment for practicing the invention. Many of the components of server device 70 may also be duplicated in a higher capability client device that a mobile use may use for browsing web pages and/or other computing activities, in addition to using the mobile device.

As shown in the figure, server device 70 includes a processing unit 72 in communication with a mass memory 74 via a bus 73. Mass memory 74 generally includes a RAM 76, a ROM 78, and other storage means. Mass memory 74 illustrates a type of computer-readable media, namely computer storage media. Computer storage media may include volatile and nonvolatile, removable and non-removable media implemented in any method or technology for storage of information such as computer readable instructions, data structures, program modules or other data. Other examples of computer storage media include EEPROM, flash memory or other semiconductor memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Mass memory 74 stores a basic input/output system (“BIOS”) 80 for controlling low-level operation of server device 70. The mass memory also stores an operating system 81 for controlling the operation of server device 70. It will be appreciated that this component may include a general purpose operating system such as a version of Windows™, UNIX, LINUX™, Solaris™, or the like. The operating system may also include, or interface with a Java virtual machine module that enables control of hardware components and/or operating system operations via Java application programs.

Mass memory 74 further includes one or more data storage units 82, which can be utilized by server device 70 to store, among other things, programs 84 and/or other data. Programs 84 may include computer executable instructions which can be executed by server device 70 to implement a markup handler application, such as a WAP handler application for transmitting, receiving, and otherwise processing WAP communications, an HTTP handler application for transmitting, receiving, and otherwise processing HTTP communications, and the like. Similarly, programs 84 can include a secure socket layer (SSL) handler application for handling secure connections, such as initiating communication with an external application in a secure fashion. Other examples of application programs include messaging applications, schedulers, calendars, web services, transcoders, database programs, word processing programs, spreadsheet programs, and so forth. Accordingly, programs 84 can process markup pages, audio, video, enable telecommunication with another user of another electronic device, and other services.

In addition, mass memory 74 stores device profile store 86 and dynamic content generator (DCG) 88. Device profile store 86 may include virtually any mechanism that is configured to receive, store, and manage device profile information, including a database, spreadsheet, document, script, file, and the like. The device profile information may be associated with a specific computing device, and as such, device profile store 86 may provide sufficient storage capability device profiles from a plurality of computing devices. The device profile information may be accessed employing a variety of mechanisms, including an identifier associated with the computing device, including a device model number, carrier identifier, MIN, telephone number, MS-ISDN, ESN, and the like.

DCG 88 may be configured to recognize that a connection is made by another computing device, obtain device profile information for the computing device, and store the information in device profile store 86. DCG 88 may obtain the device profile information from a variety of sources as described above. Additionally, DCG 88 may employ any of a variety of mechanisms to combine the obtained device profile capabilities. For example, if multiple sources provide a device profile capability that may vary, such as screen resolution, then DCG 88 may determine a single screen resolution to employ based on received information. DCG 88 may also determine differing screen resolutions for the computing device based on an application being employed, a connection throughput, and the like.

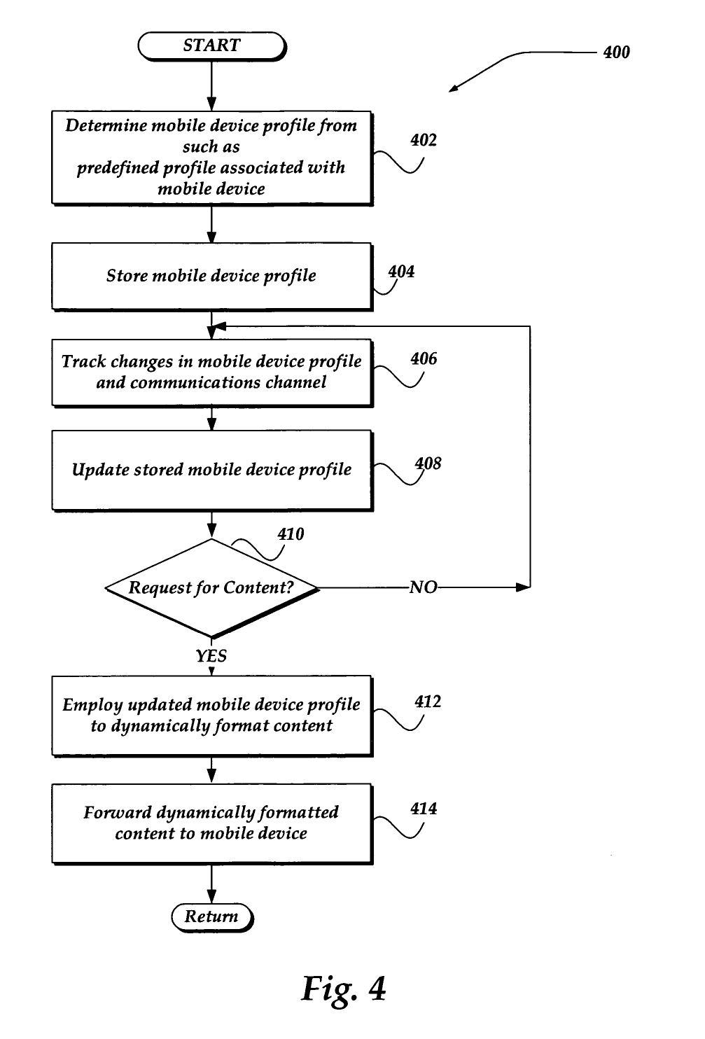

When the computing device requests content, DCG 88 may employ the determined device profile capabilities to dynamically format the requested content. The dynamically formatted content may then be provided to the requesting computing device optimized for the computing device and its network connection. DCG 88 may employ a process substantially similar to process 400 of FIG. 4 to perform at least some of its operations.

Server device 70 also includes an input/output interface 90 for communicating with input/output devices such as a keyboard, mouse, wheel, joy stick, rocker switches, keypad, printer, scanner, and/or other input devices not specifically shown in FIG. 3. A user of server device 70 can use input/output devices to interact with a user interface that may be separate or integrated with operating system 81, programs 84, and/or other modules. Interaction with the user interface includes visual interaction via a display, and a video display adapter 92.

Server device 70 may include a removable media drive 94 and/or a permanent media drive 96 for computer-readable storage media. Removable media drive 94 can comprise one or more of an optical disc drive, a floppy disk drive, and/or a tape drive. Permanent or removable storage media may include volatile, nonvolatile, removable, and non-removable media implemented in any method or technology for storage of information, such as computer readable instructions, data structures, program modules, or other data. Examples of computer storage media include a CD-ROM 99, digital versatile disks (DVD) or other optical storage, magnetic cassettes, magnetic tape, magnetic disk storage or other magnetic storage devices, RAM, ROM, EEPROM, flash memory or other memory technology, or any other medium which can be used to store the desired information and which can be accessed by a computing device.

Via a network communication interface unit 98, server device 70 can communicate with a wide area network such as the Internet, a local area network, a wired telephone network, a cellular telephone network, or some other communications network, such as network 15 in FIG. 1. Network communication interface unit 98 is sometimes known as a transceiver, transceiving device, network interface card (NIC), and the like.

Generalized Operation

The operation of certain aspects of the invention will now be described with respect to FIG. 4. FIG. 4 illustrates a logical flow diagram generally showing one embodiment of a process of dynamically generating content for a computing device based, at least in part, on a communication channel and a capability of the computing device, in accordance with the present invention. Process 400 of FIG. 4 may be employed by content server 16 of FIG. 1. Process 400 begins, after a start block, at block 402 when a mobile device initially communicates with a content server, such as described above in conjunction with FIG. 1. At block 402, the server determines a mobile device profile, sometimes called a mobile user profile from a variety of sources. For example, communication with the mobile device may provide some basic information to the content server, useable in the mobile device profile, including a device model number, a carrier identifier, MIN, MS-ISDN, ESN, or other device identifier. The content server may use the basic information to access other information regarding the mobile device from the mobile device manufacturer, distributor, trade group, and/or other sources.

The mobile device profile can also be determined based, in part, on information in a standardized user agent profile, such as that defined by the User Agent Profile Specification available from the Wireless Application Protocol Forum, Ltd. (www.wapforum.org). Another example of an information source for use in determining the mobile device profile includes Composite Capability/Preference Profiles (CC/PP), defined by the World Wide Web Consortium (www.w3c.org). Further examples of profiles describing mobile device capabilities that may be employed include a mobile information device profile (MIDP), a wireless universal resource file (WURFL), and the like. User agent profiles or other similar standardized profiles generally include attributes of a mobile device, such as a screen size, a screen resolution, a memory size, and the like. A sample user agent profile is provided in Appendix A. The content server may use a user agent profile or other standardized profile to start a mobile device profile, which may then be modified with alternate and/or additional mobile device information.

For example, the content server may initially modify the mobile device profile to add information about capabilities, services, contractual agreements, and/or limitations of the mobile user's carrier and/or service plan. For instance, the content server may use outside sources or out-band-communications to determine whether the user's carrier offers online photo management to subscribers of certain service plans. If the content server determines that the mobile user subscribes to one of those plans, that information may also be stored in the mobile device profile.

The content server can also associate the mobile device profile with a general user profile that the user may already have established with the content server. The user may already have an account through a network connection with a general purpose computing device (e.g. a PC), an entertainment system, another mobile device, and the like. The association of profiles can take multiple forms. For example, the mobile device profile may form the basis of the general user profile. Alternatively, the elements of a mobile device profile may be added to an existing general user profile. Conversely, the mobile device profile may remain separate from, but linked to the general user profile. Other associations are also possible. If the mobile user is not registered with the content server, the mobile device profile may stand alone, and be identified by the mobile device identifier. In any event, it should be clear that the mobile device profile may be determined based on a variety of information sources.

Processing next flows to block 404, where the determined mobile device profile is stored. In one embodiment, the mobile device profile is stored in a manner that enables it to be retrieved using a device identifier, a user account identifier, and the like. Processing flows next to block 406.

At block 406, the content server may monitor and/or track characteristics of and/or changes to the mobile device that may affect the determined mobile device profile. For example, the mobile user may purchase a different, and/or an additional mobile device. When the mobile user accesses the content server with a new mobile device, the content server can ask, or otherwise determine, whether the mobile user already has an existing mobile device profile and/or general user profile to which the new mobile device can be associated. For example, if the mobile user uses the same telephone number with a new mobile device (and/or a new mobile carrier), the content server can access the mobile device profile associated with that telephone number, or similar device identifier. The content server can also access a new user agent profile to obtain information about the new mobile device, and access carrier information associated with the new mobile device (and/or the new mobile carrier). The new information can be incorporated into the existing mobile device profile, or a separate mobile device profile can be associated with the original mobile device profile and/or a corresponding general user profile.

Another example of how the mobile device profile may be affected includes changes to applications that may be available on the mobile device, and the like. For example, applications and/or capabilities of the mobile device associated with the mobile device may have been revised. Hardware changes, such as additional memory may have been modified.

The mobile device profile may also be changed based on independent testing of the mobile device, information provided in communication headers, analysis of communication performance, and other information. For example, the user agent profile may indicate that a particular mobile device includes certain capabilities. However, independent testing of that mobile device by the content server and/or other services may indicate greater or lesser actual performance of the mobile device. Thus, the mobile device profile can be modified to reflect the tested capabilities. Also, the mobile profiling module may evaluate the header of communications between the mobile device and the content server. A sample header is provided in Appendix B. In addition to identifying the make, model, device identifier, screen size, and other information about the mobile device, the header may indicate, or be used to determine, communication speed, throughput, and/or other communication characteristics. The communication characteristics can be averaged and/or otherwise evaluated to determine such things as the conditions at those times that the user most often uses the mobile device, where the mobile device may have been physically located, in terms of latitude, longitude, and the like.

In addition, the communications channel between the mobile device and the content server may also affect the mobile device. For example, bandwidth, quality of service, and the like, may vary over time for the communications channel. Such information may also be tracked and used to revise the mobile device profile.

Processing then flows to block 408 where the tracked changes are employed to update the stored mobile device profile.

Process 400 next flows to decision block 408, where a determination is made whether a request for content has been received from the mobile device. If a request is received, processing flows to block 412; otherwise, processing loops back to block 406 to continue monitoring for additional changes that may affect the mobile device profile.

At block 412, the updated mobile device profile is employed to dynamically format the requested content. For example, the mobile device profile may indicate that the bandwidth to the mobile device is currently slowing down over time. The content server may then dynamically format the content for a slow communications connection by performing any of a variety of actions, including reducing resolution of graphics, sending simplified WAP card content, modifying a number of links employed within a screen display, simplifying a number of colors used, and the like. Virtually any mechanism may be employed to dynamically format the content based on information within the mobile device profile about the requesting device. Processing flows to block 414 where the dynamically formatted content is forwarded to the mobile device virtually on the fly as the content is dynamically formatted. Processing then returns to a calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions. Moreover, at least some of the blocks of the flowchart illustration, and combinations of some of the blocks in the flowchart illustration, can also be implemented using a manual mechanism, without departing from the scope or spirit of the invention.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for managing content to a mobile device over a network, comprising:
determining a mobile device profile from at least one of information provided by the mobile device and information about a communication link to the mobile device;
receiving a request for content from the mobile device;
dynamically formatting the requested content based, at least in part, on the mobile device profile; and
forwarding the dynamically formatted content to the mobile device.

2. The method of claim 1, wherein determining the mobile device profile further comprises:
monitoring for a change in the information from the mobile device; and
updating the received profile information with the monitored change in the profile.

3. The method of claim 1, wherein determining the mobile device profile further comprises receiving a general user profile that includes information about a usage of an alternate electronic device to access content over the network, wherein the alternate electronic device is in communication with a server.

4. The method of claim 1, wherein determining the mobile device profile further comprises receiving a characteristic about the mobile device from at least one of a standardized mobile device profile, and a test results performed on another mobile device substantially similar to the mobile device.

5. The method of claim 1, wherein the information about the communication link further comprises at least one of a bandwidth, a connection type, a round trip time (RTT), and a quality of service metric for the communication link.

6. The method of claim 1, wherein determining the mobile device profile further comprises receiving information about the mobile device based at least one of a user agent profile specification, a Composite Capability/Preference Profile, a mobile information device profile (MIDP), and a wireless universal resource file (WURFL).

7. The method of claim 1, wherein determining the mobile device profile further comprises:
receiving from the mobile device a mobile device identifier; and
employing the mobile device identifier to store the mobile device profile.

8. The method of claim 1, wherein dynamically formatting the requested content further comprises employing at least one characteristic in the mobile device profile to customize the content, including setting at least one of a color, a resolution, and a size of a WAP card.

9. The method of claim 1, wherein dynamically formatting the requested content further comprises formatting the content on the fly based on an available application in the mobile device, as identified by the mobile device profile.

10. A computer readable medium for use in managing content to a mobile device over a network, comprising executable instructions for performing actions:
determining a mobile device profile from at least one of information provided by the mobile device and information about a communication link to the mobile device;
receiving a request for content from the mobile device;
dynamically formatting the requested content based, at least in part, on the mobile device profile; and
forwarding by the server the dynamically formatted content to the mobile device.

11. The computer readable medium of claim 10, wherein determining the mobile device profile further comprises receiving a general user profile that includes information about a usage of an alternate electronic device to access content over the network, wherein the alternate electronic device is in communication with a server.

12. The computer readable medium of claim 10, wherein determining the mobile device profile further comprises receiving a characteristic about the mobile device from at least one of a standardized mobile device profile, and a test results performed on another mobile device substantially similar to the mobile device.

13. The computer readable medium of claim 10, wherein determining the mobile device profile further comprises receiving information about the mobile device based at least one of a user agent profile specification, a Composite Capability/Preference Profile, a mobile information device profile (MIDP), and a wireless universal resource file (WURFL).

14. A server that is configured for use in managing content to a mobile device over a network, comprising:
a transceiver for receiving and sending information to another computing device;
a processor in communication with the transceiver; and
a memory in communication with the processor and for use in storing data and machine instructions that causes the processor to perform a plurality of operations, including:
determining a mobile device profile from at least one of information provided by the mobile device and information about a communication link with the mobile device;
receiving a request for content from the mobile device;
dynamically formatting the requested content based, at least in part, on the mobile device profile and the communication link; and
forwarding the dynamically formatted content to the mobile device.

15. The server of claim 14, wherein dynamically formatting the requested content further comprises employing at least one characteristic in the mobile device profile to customize the content, including setting at least one of a color, a resolution, and a size of a WAP card.

16. The server of claim 14, wherein dynamically formatting the requested content further comprises formatting the content on the fly based on an available application in the mobile device, as identified by the mobile device profile.

17. A modulated data signal for managing content to a mobile device over a network, the modulated data signal comprising instructions that enable a computing device to perform the actions of:
enabling a determination by a server of a mobile device profile from at least one of information provided by the mobile device and information about a communication link with the mobile device;
receiving, at the server, a request for content from the mobile device;
enabling the server to dynamically format the requested content based, at least in part, on the mobile device profile and the communication link; and
forwarding by the server the dynamically formatted content to the mobile device.

18. The modulated data signal of claim 17, wherein determining the mobile device profile further comprises receiving at the server a general user profile that includes information about a usage of an alternate electronic device to access content over the network, wherein the alternate electronic device is in communication with a server.

19. The modulated data signal of claim 17, wherein determining the mobile device profile further comprises receiving at the server a characteristic about the mobile device from at least one of a standardized mobile device profile, and a test results performed on another mobile device substantially similar to the mobile device.

20. The modulated data signal of claim 17, wherein the information about the communication link further comprises at least one of a bandwidth, a connection type, a round trip time (RTT), and a quality of service metric for the communication link.

21. The modulated data signal of claim 17, wherein determining the mobile device profile further comprises receiving at the server information about the mobile device based at least one of a user agent profile specification, a Composite Capability/Preference Profile, a mobile information device profile (MIDP), and a wireless universal resource file (WURFL).

22. An apparatus of managing content to a mobile device over a network, comprising:
a transceiver for receiving and sending information to another computing device;
a means for determining a mobile device profile based, at least in part, on information provided by the mobile device and information about a communication link with the mobile device;
a means for receiving a request for content from the mobile device;
a means for dynamically formatting the requested content based, at least in part, on the mobile device profile and the communication link; and
a means for forwarding the dynamically formatted content to the mobile device.
